(19) United States
(12) Patent Application Publication
(10) Pub. No.: US 2019/0142062 A1
(43) Pub. Date: May 16, 2019

(54) SYSTEM AND METHOD TO IMPLEMENT A COGNITIVE QUIT SMOKING ASSISTANT

(71) Applicant: INTERNATIONAL BUSINESS MACHINES CORPORATION, Armonk, NY (US)

(72) Inventors: Pankaj S. Dayama, Bangalore (IN); Disha Shrivastava, BANGALORE (IN)

(21) Appl. No.: 15/811,964

(22) Filed: Nov. 14, 2017

(51) Int. Cl. A24F 47/00

(52) U.S. Cl. CPC A24F 47/00; G06Q 10/1093

(57) ABSTRACT

A computer-implemented method for providing a cognitive quit smoking assistant. The method includes detecting one or more smoking triggers of the user by using one or more sensors associated with a computing device of the user, wherein the input triggers may comprise physical inputs, mental inputs, and social and pattern inputs. The method includes predicting a smoking event of the user based on receiving the detected one or more smoking triggers of the user and one or more lead indicators for a smoking event of the user. The method further includes providing the user with one or more context specific distraction suggestions to avoid the smoking event, and detecting whether the user has followed the one or more context specific distraction suggestions. The method further includes receiving feedback, from the user, to the one or more context specific distraction suggestions.

### BACKGROUND

The present disclosure relates generally to the field of cognitive computing and more particularly to data processing and implementing a cognitive quit smoking assistant for a user.

Smoking is the leading cause of preventable death. Worldwide, tobacco use causes nearly 6 million deaths per year, and current trends show that tobacco use will cause more than 8 million deaths annually by 2030. Out of every 5 people only 1 is able to quit, 3 are likely to start again and 1 dies in the process.

Currently, there are independent systems for assisting people to quit smoking but they are primarily based on manual input from the user. In various circumstances, users may not give the correct input to the system regarding smoking behavior, thus making these systems prone to errors.

### SUMMARY

Embodiments of the invention include a method, computer program product, and system, for assisting a user to quit smoking.

The method includes detecting one or more smoking triggers of the user, wherein the input triggers may comprise physical inputs, mental inputs, and social and pattern inputs. The method further includes predicting a smoking event of the user based on receiving the detected one or more smoking triggers of the user and one or more lead indicators for a smoking event of the user. The method further includes providing the user with one or more context specific distraction suggestions to avoid the smoking event, and tracking progress of the user based on the user following the one or more context specific distraction suggestions. The method further includes receiving feedback, from the user, to the one or more context specific distraction suggestions.

A computer program product, according to an embodiment of the invention, includes a non-transitory tangible storage device having program code embodied therewith. The program code is executable by a processor of a computer to perform a method. The method includes detecting one or more smoking triggers of the user, wherein the input triggers may comprise physical inputs, mental inputs, and social and pattern inputs. The method further includes predicting a smoking event of the user based on receiving the detected one or more smoking triggers of the user and one or more lead indicators for a smoking event of the user. The method further includes providing the user with one or more context specific distraction suggestions to avoid the smoking event, and tracking progress of the user based on the user following the one or more context specific distraction suggestions. The method further includes receiving feedback, from the user, to the one or more context specific distraction suggestions.

A computer system, according to an embodiment of the invention, includes one or more computer devices each having one or more processors and one or more tangible storage devices; and a program embodied on at least one of the one or more storage devices, the program having a plurality of program instructions for execution by the one or more processors. The program instructions implement a method. The method includes detecting one or more smoking triggers of the user, wherein the input triggers may comprise physical inputs, mental inputs, and social and pattern inputs. The method further includes predicting a smoking event of the user based on receiving the detected one or more smoking triggers of the user and one or more lead indicators for a smoking event of the user. The method further includes providing the user with one or more context specific distraction suggestions to avoid the smoking event, and tracking progress of the user based on the user following the one or more context specific distraction suggestions. The method further includes receiving feedback, from the user, to the one or more context specific distraction suggestions.

### BRIEF DESCRIPTION OF THE SEVERAL VIEWS OF THE DRAWINGS

FIG. 1 illustrates cognitive computing environment 100, in accordance with an embodiment of the present invention.

FIG. 2 is a flowchart illustrating the operation of cognitive quit smoking assistant 120 of FIG. 1, in accordance with an embodiment of the present invention.

FIG. 3 is a block diagram illustrating the input features of distraction suggestion provider 126 of FIG. 1, in accordance with an embodiment of the present invention.

FIG. 4 illustrates sequential distraction suggestion model 300 of FIG. 3 in cognitive quit smoking assistant 120 of FIG. 1, in accordance with an embodiment of the present invention.

FIG. 5 depicts an example sequential distraction suggestion model 300 of FIG. 3 in cognitive quit smoking assistant 120 of FIG. 1, in accordance with an embodiment of the present invention.

FIG. 6 is a diagram graphically illustrating the hardware components of a computing environment of FIG. 1, in accordance with an embodiment of the present invention.

FIG. 7 depicts a cloud computing environment, in accordance with an embodiment of the present invention.

FIG. 8 depicts abstraction model layers of the illustrative cloud computing environment of FIG. 7, in accordance with an embodiment of the present invention.

### DETAILED DESCRIPTION

The current models for predictive smoking behavior, of a user, have limited inputs, and as such, few systems can predict when a person will smoke a cigarette. Moreover, current models are not dynamic and adaptive to contexts, previous history and other factors such as group smoking network, organization hierarchy, etc.

The existing systems do not effectively use the data of whether the person has smoked, or not, post-suggesting distraction to effectively change the intensity of suggestions or deciding what is the next best distraction to suggest which is more likely to be accepted.

Therefore, there is a genuine necessity for an adaptive and sequential system for context specific distraction suggestions to a user; an intelligent system to track behavior patterns and feedback from previous history, of a user, to suggest more effective distractions based on the user's situational context, group smoking network and smoking triggers.

Additionally, there is no system that considers smoking triggers from other users by looking at influential nodes. For example, influential nodes may be based on one's social circle, organization hierarchy, etc.

Hereinafter, exemplary embodiments of the present invention will be described in detail with reference to the attached drawings.

The present invention is not limited to the exemplary embodiments below, but may be implemented with various modifications within the scope of the present invention. In addition, the drawings used herein are for purposes of illustration, and may not show actual dimensions.

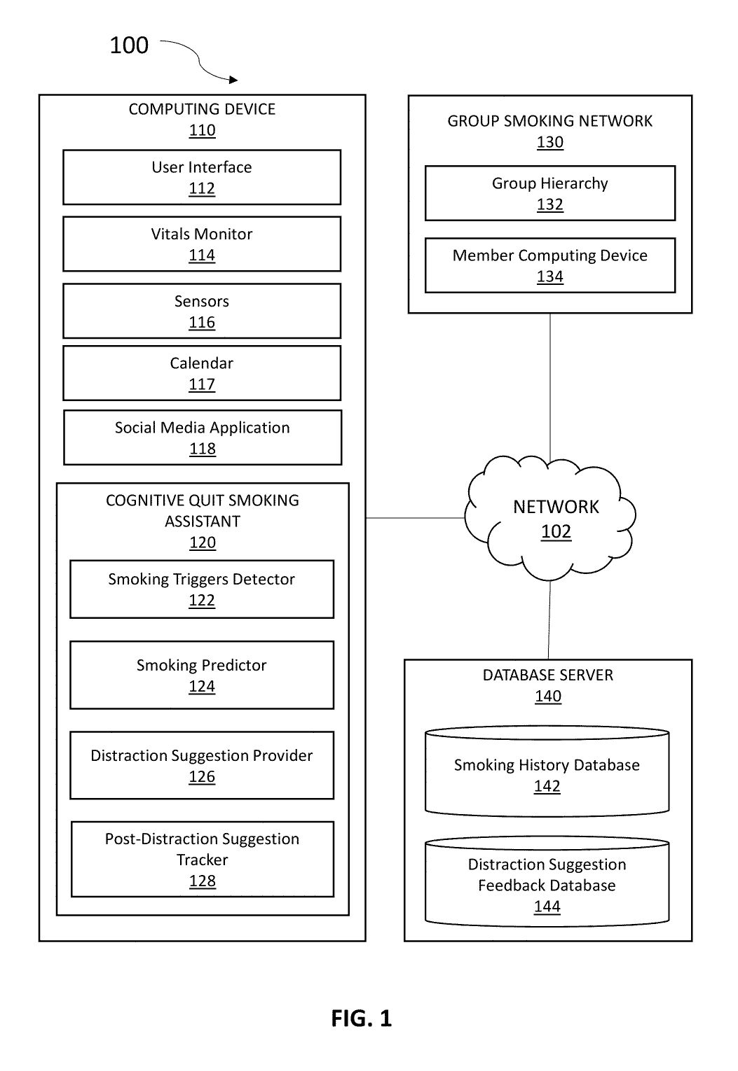

FIG. 1 illustrates cognitive computing environment 100, in accordance with an embodiment of the present invention. Cognitive computing environment 100 includes computing device 110, group smoking network 130, and database server 140 all connected via network 102. The setup in FIG. 1 represents an example embodiment configuration for the present invention, and is not limited to the depicted setup in order to derive benefit from the present invention.

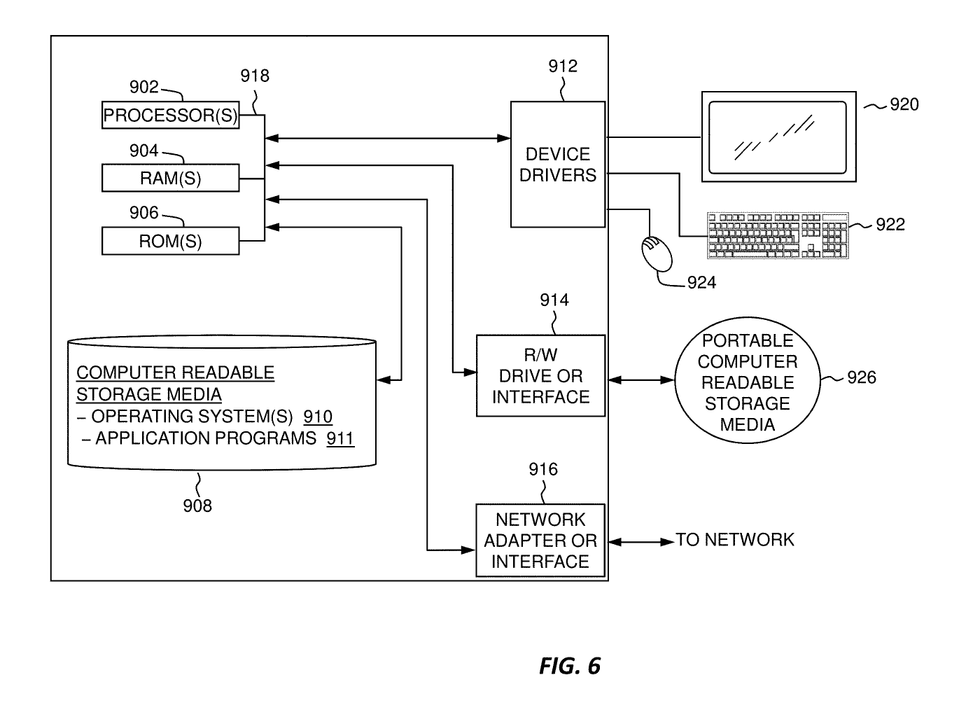

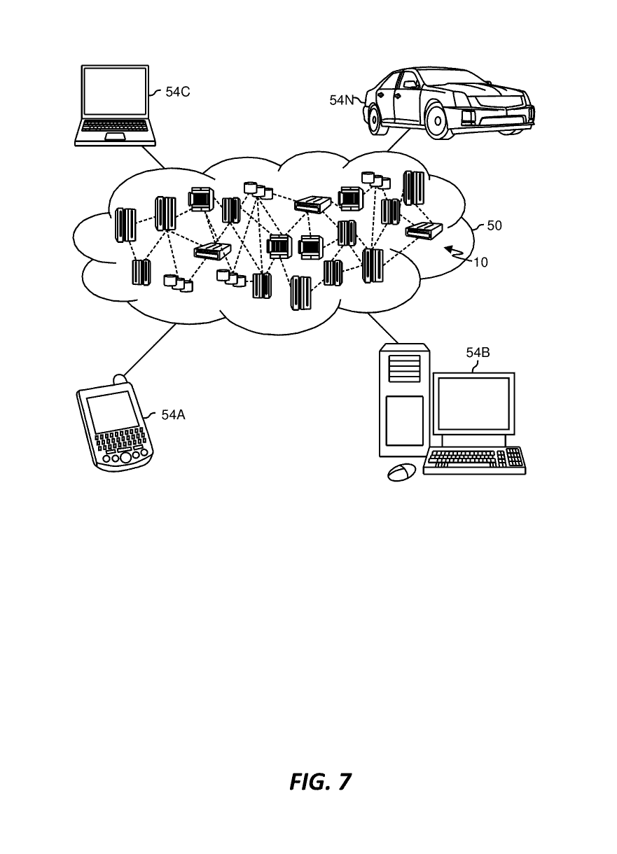

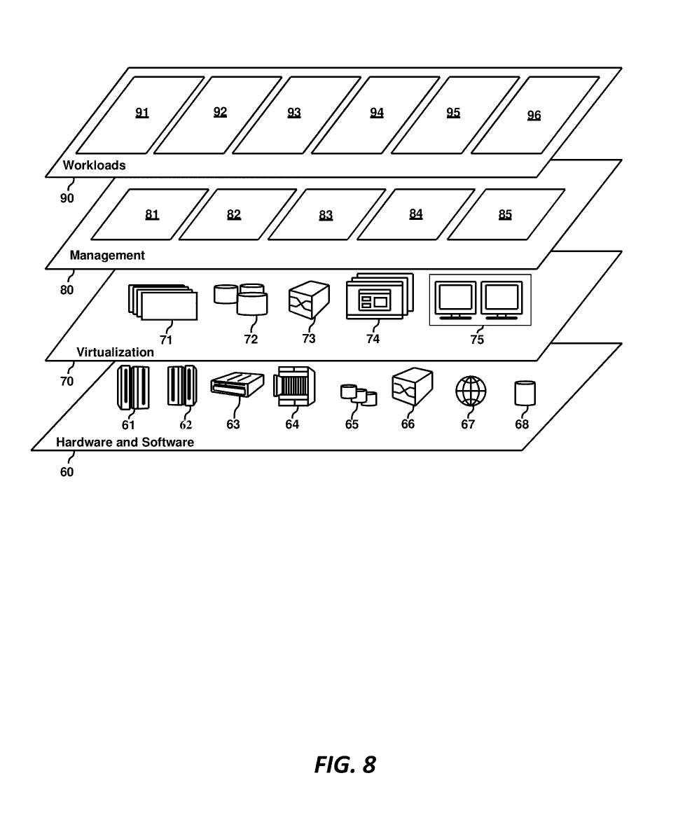

In the example embodiment, computing device 110 contains user interface 112, vitals monitor 114, sensors 116, calendar 117, social media application 118, and cognitive quit smoking assistant 120. In various embodiments, computing device 110 may be a laptop computer, tablet computer, netbook computer, personal computer (PC), a desktop computer, a personal digital assistant (PDA), a smart phone, or any programmable electronic device capable of communicating with group smoking network 130, and database server 140 via network 102. Computing device 110 may include internal and external hardware components, as depicted and described in further detail below with reference to FIG. 6. In other embodiments, computing device 110 may be implemented in a cloud computing environment, as described in relation to FIGS. 7 and 8, herein. Computing device 110 may also have wireless connectivity capabilities allowing it to communicate with group smoking network 130, database server 140, and other computers or servers over network 102.

In an example embodiment, computing device 110 includes user interface 112, which may be a computer program that allows a user to interact with computing device 110 and other connected devices via network 102. For example, user interface 112 may be a graphical user interface (GUI). In addition to comprising a computer program, user interface 112 may be connectively coupled to hardware components, such as those depicted in FIG. 6, for receiving user input. In the example embodiment, user interface 112 is a web browser, however in other embodiments user interface 112 may be a different program capable of receiving user interaction and communicating with other devices.

In an example embodiment, vitals monitor 114 may be a computer program, on computing device 110, that detects and monitors a user's vital signs which may include blood pressure, cholesterol levels, blood sugar levels, heart rate and so on. In other embodiments, vitals monitor 114 may be a separate device such as a blood glucose monitor, a heart rate monitor, or a wearable device that detects one or more of a user's vital signs, and communicates with computing device 110. Vitals monitor 114 outputs detected and monitored vital signs of a user to cognitive quit smoking assistant 120, either on a continuous basis or at set intervals. In other embodiments, vitals monitor 114 may be configured to detect and monitor a user's vital signs based on any method known to one of ordinary skill in the art.

In an example embodiment, sensors 116 may be an electronic hardware component, module, or subsystem capable of detecting events or changes in a user environment and sending the detection data to other electronics (e.g. a computer processor), components (e.g. database server 140), or programs (e.g. cognitive quit smoking assistant 120) within a system such as cognitive computing environment 100. In various embodiments, the detection data collected by sensors 116 may be instrumental in determining mental states of a user (e.g. happy, sad, depressed, bored, etc.) as known to one of ordinary skill in the art. For example, sensors 116 may be capable of running in the background of computing device 110, all the while collecting information such as the time it takes for a user to respond to questions, scrolling and clicking patterns on websites, sleep activity patterns, and history of phone calls and texts to measure a state of mind of a user.

Sensors 116, in an exemplary embodiment, may be located within, or near, computing device 110 and may be a global positioning system (GPS), software application, proximity sensor, camera, microphone, light sensor, infrared sensor, weight sensor, temperature sensor, tactile sensor, motion detector, optical character recognition (OCR) sensor, occupancy sensor, heat sensor, analog sensor (e.g. potentiometers, force-sensing resistors), radar, radio frequency sensor, video camera, digital camera, Internet of Things (IoT) sensors, lasers, gyroscopes, accelerometers, structured light systems, user tracking sensors (e.g. eye, head, hand, and body tracking positions of a user), and other devices used for measuring an environment or current state of the user and/or the physical environment of the user. In the example embodiment, sensors 116 is referenced via network 102.

In exemplary embodiments, the data collected from sensors 116 may be useful in assisting cognitive quit smoking assistant 120 to detect a user context before, during, or after a user engages with smoking a cigarette. Sensors 116 may also play a critical role in determining smoking triggers for a user.

In an example embodiment, calendar 117 may be a computer program, on computing device 110, that syncs a user's electronic calendar from another computing device, or application, to calendar 117. Calendar 117 may include a user's personal calendar such as birthdays, vacation dates, travelling schedule, personal event information, as well as a user's work calendar such as meeting dates/times, conference dates/times, travelling schedule dates/times, and so forth. Calendar 117, in the example embodiment, is capable of communicating with cognitive quit smoking assistant 120.

In an example embodiment, social media application 118 is a computer program, on computing device 110, that is capable of receiving manually input status updates of a user, location identifier of a user, streaming/live video, photographs, check-ins at restaurant/bar/stadium establishments, and so forth, from a user, which may be consolidated and analyzed and provide a glimpse into social activity patterns of a user. The more frequently, consistently, and accurately a user interacts with a social media application 118, the more genuine of a measurement of social patterns (e.g. when a person eats, sleeps, engages in social events) for a user may be obtained.

With continued reference to FIG. 1, group smoking network 130 may include a group hierarchy 132 and member computing devices 134. In an exemplary embodiment, group smoking network 130 may include a plurality of multiple users, each user comprising a node, arranged in a group hierarchy 132 structure. The group hierarchy 132 positions influential smokers (e.g. a boss) relative to his peers, or nodes, thus depicting the flow of influence from one node to the next. In an exemplary embodiment, the smoking pattern of the boss may affect the smoking pattern of the rest of the nodes, or peers. For example, the probability that each peer will smoke a cigarette, relative to the boss smoking a cigarette, may be calculated from social network analysis methods and historical smoking data of all members of group smoking network 130.

In an exemplary embodiment, member computing device 134 may be a laptop computer, tablet computer, netbook computer, personal computer (PC), a desktop computer, a personal digital assistant (PDA), a smart phone, or any programmable electronic device capable of communicating with computing device 110, and database server 140 via network 102. Member computing device 134 may include internal and external hardware components, as depicted and described in further detail below with reference to FIG. 6. In other embodiments, member computing device 134 may be implemented in a cloud computing environment, as described in relation to FIGS. 7 and 8, herein. Member computing device 134 may also have wireless connectivity capabilities allowing it to communicate with computing device 110, database server 140, and other computers or servers over network 102.

In an exemplary embodiment, smoking data for each member of group smoking network 134 may be collected from member computing device 134 using the same methods as discussed above for computing device 110 (e.g. vitals monitor 114, sensors 116, social media application 118). For example, given the stamped smoking data for all members of group smoking network 134 stored in smoking history database 142, a group hierarchy 132 for the group smoking network 134 may be constructed wherein the strength of the edges that connect nodes, or peers, are defined using association rule mining or any other methods known to one of ordinary skill in the art. In exemplary embodiments, the smoking habits of members in the group smoking network 134 may be one factor that contributes to triggering a smoking event for a user.

With continued reference to FIG. 1, database server 140 includes smoking history database 142 and distraction suggestion feedback database 144 and may be a laptop computer, tablet computer, netbook computer, personal computer (PC), a desktop computer, a personal digital assistant (PDA), a smart phone, a server, or any programmable electronic device capable of communicating with computing device 110 and group smoking network 130 via network 102. While database server 140 is shown as a single device, in other embodiments, database server 140 may be comprised of a cluster or plurality of computing devices, working together or working separately.

In an example embodiment, smoking history database 142 may contain the number of cigarettes, time of day, duration of smoking event, and number of smoking events for a user, as well as one or more users within a group smoking network 130, over a given day/week/month/year. Smoking history database 142 may also contain values corresponding to the effectiveness of a context specific distraction suggestion for a particular user for a particular user context and mood. In exemplary embodiments, smoking history database 142 may be organized according to a user name (e.g. user1, user2 . . . userN), mood (e.g. anxious, happy, sad, bored), and location (bar, work, party), or any other category or organization deemed most useful for the invention to be utilized.

In an exemplary embodiment, distraction suggestion feedback database 144 may contain feedback from a user indicating whether a particular context specific distraction suggestion was effective or not. For example, a 1 may indicate that the context specific distraction suggestion was effective (i.e. <bored, “send an article to read”, 1>) while a 0 may indicate that the context specific distraction suggestion was not effective (i.e. <anxious, “have a fun conversation with a chat-bot”, 0>). In exemplary embodiments, the greater the amount of data stored in distraction suggestion feedback database 144 for various context specific scenarios of a user, the more effective future context specific distraction suggestions may be.

In various embodiments, smoking history database 142 and/or distraction suggestion feedback database 144 are capable of being stored on cognitive quit smoking assistant 120, or computing device 110, as a separate database.

In the example embodiment, network 102 is a communication channel capable of transferring data between connected devices and may be a telecommunications network used to facilitate telephone calls between two or more parties comprising a landline network, a wireless network, a closed network, a satellite network, or any combination thereof. In another embodiment, network 102 may be the Internet, representing a worldwide collection of networks and gateways to support communications between devices connected to the Internet. In this other embodiment, network 102 may include, for example, wired, wireless, or fiber optic connections which may be implemented as an intranet network, a local area network (LAN), a wide area network (WAN), or any combination thereof. In further embodiments, network 102 may be a Bluetooth network, a WiFi network, or a combination thereof. In general, network 102 can be any combination of connections and protocols that will support communications between computing device 110, group smoking network 130, and database server 140.

With continued reference to FIG. 1, cognitive quit smoking assistant 120, in the example embodiment, may be a computer application on computing device 110 that contains instruction sets, executable by a processor. The instruction sets may be described using a set of functional modules. Cognitive quit smoking assistant 120 receives input from user interface 112, vitals monitor 114, sensors 116, calendar 117, social media application 118, group smoking network 130, and database server 140. In alternative embodiments, cognitive quit smoking assistant 120 may be a standalone program on a separate electronic device.

In an exemplary embodiment, the functional modules of cognitive quit smoking assistant 120 include smoking triggers detector 122, smoking predictor 124, distraction suggestion provider 126, and post-distraction suggestion tracker 128.

With continued reference to FIG. 1, cognitive quit smoking assistant 120 may effectively assist a user to quit smoking by using a combination of the following novel features. Cognitive quit smoking assistant 120 may be capable of detecting smoking triggers of the user. Based on the detection of a user's smoking triggers, cognitive quit smoking assistant 120 may learn lead indicators for a smoking event of the user, thus predict, based on smoking history of a user, when a user is about to smoke a cigarette. Cognitive quit smoking assistant 120 may then provide an adaptive and context specific distraction suggestion to the user to try and distract the user from smoking a cigarette at that moment. The system may be capable of detecting, without depending on conscious input from the user, whether a context specific distraction suggestion was successful in distracting a user from smoking or not. According to an embodiment, the one or more context specific distraction suggestions may be sequential and increase in intensity based on distraction suggestion feedback from the user.

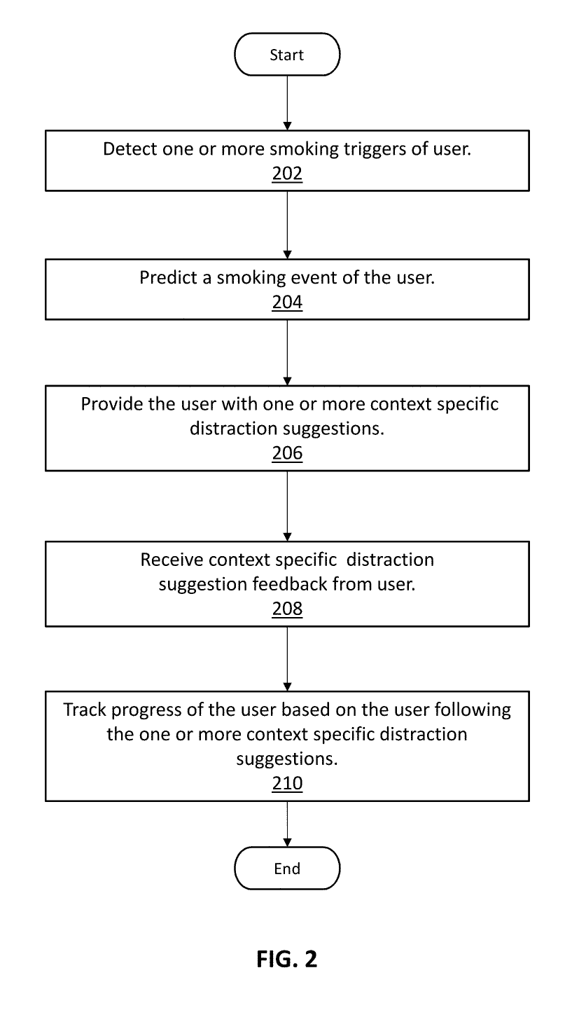

FIG. 2 is a flowchart illustrating the operation of cognitive quit smoking assistant 120 of FIG. 1, in accordance with embodiments of the present invention.

With reference to FIGS. 1 and 2, smoking triggers detector 122 includes a set of programming instructions, in cognitive quit smoking assistant 120, to detect one or more smoking triggers of the user by using one or more sensors 116 associated with a computing device 110 of the user (step 202). In exemplary embodiments, smoking triggers may include social events/gatherings, emotional state of a user, physical and sensory stimuli, health status of a user, and various day-to-day life patterns of a user. Smoking patterns may be broken down into categories that may include physical triggers, emotional triggers, pattern triggers, and social triggers.

In exemplary embodiments, smoking triggers detector 122 may detect the various categories of smoking triggers for a user by receiving a plurality of inputs of the user which may include physical inputs, emotional inputs, social inputs and pattern inputs. These inputs may be received, by smoking triggers detector 122, via various means, including but not limited to vital monitor 114, sensors 116, calendar 117, social media application 118, group smoking network 130, and database server 140.

In exemplary embodiments, physical triggers of a user may include blood pressure, heart rate count, blood/glucose levels, brainwave activity, and so forth.

In exemplary embodiments, emotional triggers of a user may include stressed, anxious, excited, bored, down, happy, lonely, satisfied, and cooled off after a fight.

In exemplary embodiments, social triggers of a user may include going to a bar, going to a party or other social event, going to a concert, seeing someone else smoke, being with friends who smoke, celebrating a big event, and user approaching a smoking room.

In exemplary embodiments, pattern triggers of a user may include talking on the phone, drinking alcohol, watching TV, driving, finishing a meal, drinking coffee, taking a work break, after having sex, and before going to bed.

Smoking triggers detector 122 may be capable of converting the various detected user inputs into assigned smoking trigger values based on smoking history of a user, stored in smoking history database 142. In an exemplary embodiment, a value between 0-1 may be assigned for each received input, corresponding to a likelihood value that the user will smoke, based on user history smoking data. For example, physical inputs of a user may indicate that the user is experiencing high blood pressure (i.e. high probability of smoking [1]), is stressed (i.e. medium probability of smoking [0.5]), and sees a co-worker going outside to smoke a cigarette (i.e. high probability of smoking [1]). These values are then output to smoking predictor 124 to determine the probability of the user smoking a cigarette under the circumstances.

With continued reference to FIGS. 1 and 2, smoking predictor 124 includes a set of programming instructions, in cognitive quit smoking assistant 120, to predict a smoking event of the user based on receiving the detected one or more smoking triggers of the user and one or more lead indicators for a smoking event of the user (step 204). In exemplary embodiments, the one or more lead indicators for a smoking event of the user may include smoking trigger values, a user-situational context, historical smoking data of the user (i.e. trigger, smoking activity, distraction suggestion, effectiveness), and group smoking network influences of the user.

In an exemplary embodiment, smoking predictor 124 receives the one or more lead indicators for a smoking event of the user, and processes the values via a machine learning (ML) based model. The ML based model is capable of creating a user specific set of rules for predicting when a user is going to smoke a cigarette and, thus, refines the user-specific set of rules (e.g. susceptibility to having a cigarette based on the various smoking triggers and lead indicators for a smoking event) based on whether the user had a cigarette, as well as the continued feedback received from the user.

Smoking predictor 124 is an adaptive ML based model that learns the user-specific leading indicators as well as a user-specific set of rules for any smoking event based on a user's group smoking network 130, along with group hierarchy 132, a user's situational context and schedule, user-specific smoking trigger patterns, historical distraction suggestion and acceptance data, and smoking history data, which may include distraction suggestions that were successful in preventing the user from smoking, and distraction suggestions that were unsuccessful in preventing the user from smoking.

In an exemplary embodiment, a user-specific set of rules, developed by smoking predictor 124, may determine a probability of the user engaging in a smoking event based on previous history data, and the various inputs received from smoking triggers detector 122. Based on a user-specific set of rules, smoking predictor 124 may adapt to the user's smoking behavior in various contexts and circumstances. For example, smoking predictor 124 may build a group smoking network 130 comprising a network of nodes, wherein each node corresponds to a peer of the user that is influential in having the user engage in a smoking event. One such user-specific rule may be that if the peer corresponding to a lead node (i.e. a boss) in group smoking network 130 has not smoked, then the user will not smoke with x % probability.

Another example of a user-specific rule developed by smoking predictor 124 may be that if a user is bored and has not engaged in a smoking event in the past two hours, then the user is likely to smoke in the next hour with x % probability.

Another example of a user-specific rule developed by smoking predictor 124 may be that if a user goes to a pub with friends who smoke, then the user is likely to smoke with x % probability.

Another example of a user-specific rule developed by smoking predictor 124 may be that if a user feels stressed and is alone, then the user is likely to smoke in the next five minutes with x % probability.

Based on the user-specific set of rules that encompass various situational contexts of the user, smoking predictor's 124 ML based model changes dynamically based on the feedback, as well as inputs, received from the user. As such, smoking predictor 124 is capable of dynamically adapting its set of user-specific rules to actual changes in smoking habits of the user. Additionally, the predictive ML model of smoking predictor 124 is able to adapt to the user based on changes in the user's group smoking network 130, as well as the user's smoking and distraction temporal data.

With continued reference to FIGS. 1 and 2, distraction suggestion provider 126 includes a set of programming instructions, in cognitive quit smoking assistant 120, to provide the user with one or more context specific distraction suggestions to avoid the smoking event (step 206). In exemplary embodiments, one or more context specific distraction suggestions may include a suggestion, by distraction suggestion provider 126, based on the location and context of the user. For example, if a user is feeling sad then distraction suggestion provider 126 may try to make user feel happy by playing a funny video/favorite song on user's computing device 110 when the user is alone. Distraction suggestion provider 126, in another embodiment, may change the appearance of a user's screensaver/send a funny message to user's computing device 110 when the user is in the office.

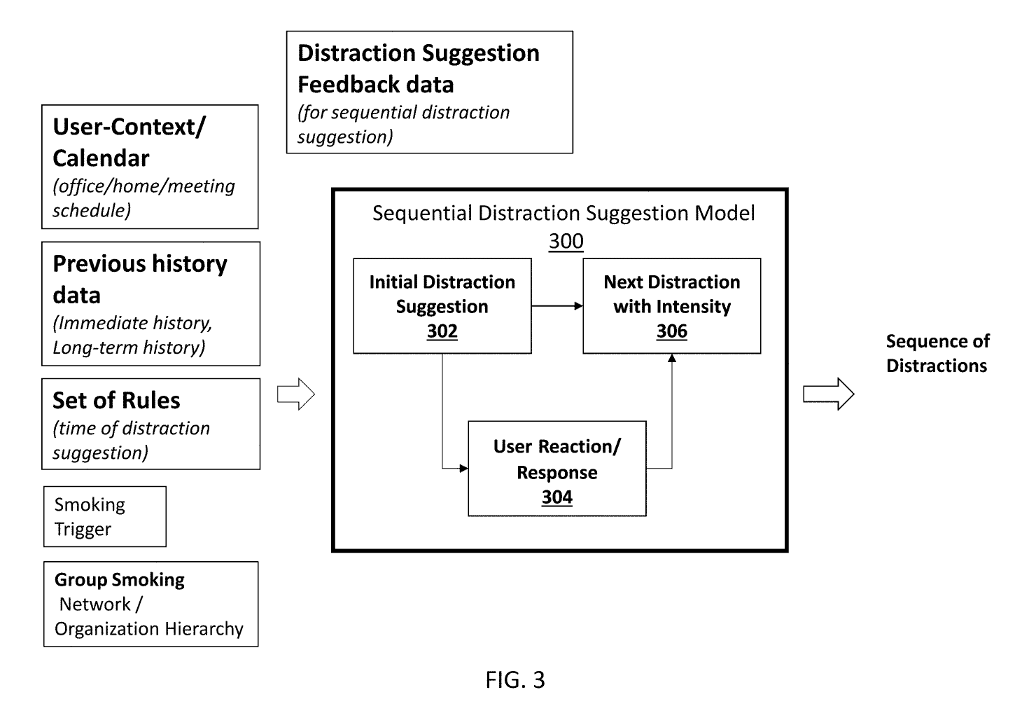

FIG. 3 is a block diagram illustrating the input features of distraction suggestion provider 126 of FIG. 1, in accordance with an embodiment of the present invention.

With reference to FIGS. 1-3, distraction suggestion provider 126 provides an adaptive and context specific distraction suggestion (e.g. intensity and/or sequential) to a user based on the various inputs, which include the following: smoking triggers, user-context, previous history data (e.g. immediate history and long-term history), set of user-specific rules received from smoking predictor 124, group smoking network/organization hierarchy, and distraction suggestion feedback data (for sequential distraction suggestions).

In order to increase the chances of preventing a user from engaging in a smoking event, distraction suggestion provider 126 provides adaptive and context-specific sequential distraction suggestions with increasing intensity, based on the user specific set of rules learned from smoking predictor 124, which includes user current context and schedule, group smoking network 130 attributes/indicators, historical distraction suggestion and acceptance data, smoking history data, and user response data to recent distraction suggestion sequences.

In exemplary embodiments, distraction suggestion provider 126 outputs context and trigger based sequential distraction suggestions to a user at a predicted smoking time, as determined by smoking predictor 124. For example, if a user is bored, the system may occupy the user's mind by sending a puzzle/game to the user's computing device 110 or suggest to the user to talk to a friend to keep occupied.

In exemplary embodiments, distraction suggestion provider 126 considers smoking history data of a user, of which there may be two types: immediate history and long-term history. With regards to immediate history smoking data of the user, the intensity of a distraction suggestion, provided by distraction suggestion provider 126, may be based on how the user is following (i.e. how distracted is the user) a previous distraction suggestion or not. For example, if the distraction suggestion intervention is too strong or direct, the user may not abide. As such, distraction suggestion provider 126 may start with a weak, or lower-rated, distraction suggestion and gradually provide stronger, or higher-rated, distraction suggestions, tailored to the user and the user's context, in order to increase the likelihood of a user abiding by the suggestions.

With regards to long-term history smoking data of the user, distraction suggestion provider 126 may evaluate the smoking history data of a user over a long period of time (e.g. over a week/month/year). Based on the long-term smoking history data of the user, distraction suggestion provider 126 may have a more accurate picture of the user's smoking history, along with distraction suggestion feedback data that may have been successful for various contextual circumstances of the user.

In exemplary embodiments, distraction suggestion provider 126 may be capable of utilizing the user-specific set of rules, received from smoking predictor 124, to determine an appropriate (i.e. likelihood of the user abiding by the distraction suggestion) time for suggesting a particular distraction to the user.

In exemplary embodiments, distraction suggestion provider 126 may be capable of taking into consideration the effect of group smoking patterns and influences, as depicted in a group smoking network 130 of the user, by considering the flow of influence from the influential peer nodes in the node graph/hierarchy of peer smokers in a user's group hierarchy 132.

In exemplary embodiments, distraction suggestion provider 126 may receive context specific distraction suggestion feedback from user (step 208). In alternative embodiments, distraction suggestion provider 126 may be capable of dynamically adapting its distraction suggestions to a user, based on the response received from a chat-bot/automatic phone call to the user. For example, if a user does not answer the automatic phone call, or hangs up right away, then distraction suggestion provider 126 may determine that the distraction suggestion was not strong enough, or relevant, for the user's context. As such, an alternative distraction suggestion (e.g. sending a video) may be provided to the user instead.

With continued reference to FIGS. 1-3, distraction suggestion provider 126 follows a sequential distraction suggestion model 300. This means that distraction suggestion provider 126 considers the various above-mentioned inputs (i.e. user context, smoking history data, user specific set of rules, smoking triggers, group smoking network, and distraction suggestion feedback data) and provides an initial distraction suggestion 302 to the user.

In exemplary embodiments, examples of distraction suggestions may include: Sending a newspaper article to the user's electronic device, or uploading an interesting game or puzzle to the user's electronic device; Playing a funny video/their favorite song/photos to cheer up the user's mood when dull; Sending motivational quotes to the user's electronic device; Highlighting savings in cost for not smoking; Highlighting improvements in health and overall stamina for not smoking; Suggesting to take meditation, e.g. if the person is suffering from headache, suggest that she consume a tablet to cure headache or a nicotine patch for chain smokers in their initial stages; Suggesting a user to talk to their friend/loved ones when they feel anxious/stressed out or make the friend/loved ones call the user; and Sending an automated voice-call from a chat-bot which keeps the user engaged.

In exemplary embodiments, distraction suggestion provider 126 obtains the user's reaction/response 304 to the initial distraction suggestion 302, via a chat-bot, automatic phone call, or any other method known to one of ordinary skill in the art, and determines whether to provide a more intensive successive distraction suggestion 306 in the event the initial distraction suggestion 302 did not distract the user from smoking.

The user's reaction/response 304 (i.e. user feedback) to the distraction suggestion may assist distraction suggestion provider 126 in determining which distraction suggestions, at a particular time and place, were effective at distracting the user from engaging in a smoking event.

In an exemplary embodiment, distraction suggestion provider 126 may alternatively provide a more intensive successive distraction suggestion 306 to the user, based on dynamic adaptation of the distraction suggestions following the user's reactions/responses 304.

With continued reference to FIGS. 1-3, distraction suggestion provider 126 may be capable of detecting whether the user has followed the initial distraction suggestion 302. In exemplary embodiments, distraction suggestion provider 126 checks a user context with a user's prior smoking history data in order to refine its adaptive and context specific distraction suggestions. In other words, distraction suggestion provider 126 persists with distraction suggestions that are effective (i.e. distract the user from engaging in a smoking event), and continues to refine, or adapt, the sequential distraction suggestions based on the user's various contextual inputs.

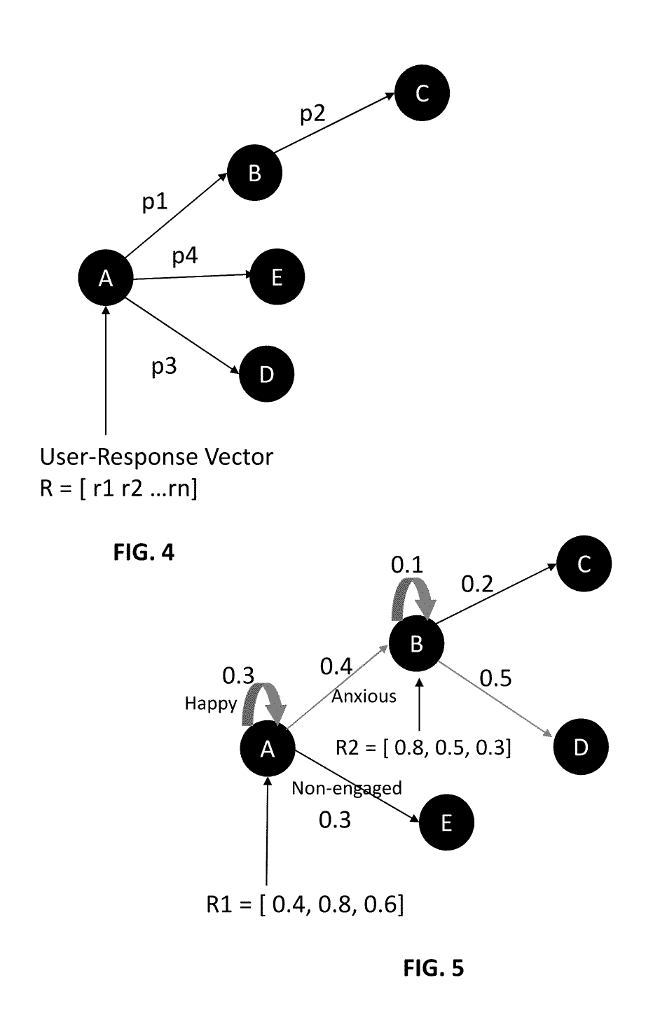

FIG. 4 illustrates sequential distraction suggestion model 300 of FIG. 3 in cognitive quit smoking assistant 120 of FIG. 1, in accordance with an embodiment of the present invention.

With reference to FIG. 4, sequential distraction suggestion model 300 may contain various nodes (e.g. nodes A-E) and edges (e.g. edges p1-p4) wherein the edges connect one node to another. Each node in the graph represents a distraction suggestion. Each edge in the graph has a weight attached to it which represents prior probabilities of effectiveness of prior distraction suggestions provided to a user. For example, node A may represent “sending an article to the user to read”; node B may represent “having a fun conversation with a chat-bot”; node C may represent “an automated voice call”; node D may represent “suggesting to the user to take a medication”; and node E may represent “sending the user a video”.

In exemplary embodiments, traversal of the graph is based on the product of a user response to a distraction suggestion and prior probabilities of effectiveness of prior distraction suggestions provided to the user. This calculation may be referred to as a user-response vector and may be indicated as follows: R=[r1, r2, . . . rn] wherein R represents user-Response, and r1-rn represent a number (e.g. 0-1) indicating a measurement of effectiveness of the user response at a particular node for a particular distraction suggestion. In exemplary embodiments, distraction suggestion provider 126 processes the user-response vector calculation in order to derive a mathematically effective distraction suggestion, based on the measurement of prior effectiveness of the distraction suggestion.

FIG. 5 depicts an example sequential distraction suggestion model 300 of FIG. 3 in cognitive quit smoking assistant 120 of FIG. 1, in accordance with an embodiment of the present invention.

In an exemplary embodiment, and with reference to FIG. 5, values in the user-response vector may indicate how the user is responding to a particular distraction suggestion. An example may be the measurement of how engaged the user is with respect to the distraction suggested or how happy-sad or relaxed-stressed the user is with respect to the distraction suggested. At each node, the user-response vector is measured. For example, R=[happy, anxious, non-engagement level].

With continued reference to FIG. 5, edge probabilities denote the transition probabilities in going from one category of distraction to another. In an exemplary embodiment, the edge probabilities for a new user may be randomly initialized or may be initialized based on the values from a user that shares the same, or similar, pattern inputs as the current user. Over time, the edge probabilities may then be updated as cognitive quit smoking assistant 120 learns specific user patterns and incorporates the user's distraction suggestion feedback history.

With continued reference to FIG. 5, R1 is component-wise multiplied with edge probabilities at node A (i.e. remain at node A [0.3], edge to node B [0.4], and edge to node E [0.3]). The edge corresponding to the component that has a maximum value is traversed. For example, distraction suggestion provider 126 begins at node A and, using user-response vector R1, computes the maximum value for the various computations (0.4*0.3=0.12; 0.8*0.4=0.32; 0.6*0.3=0.18). Since the maximum value (0.32) occurs when the user traverses the A-B edge, distraction suggestion provider 126 determines that the user is getting anxious, which may indicate that cognitive quit smoking assistant 120 needs to suggest a better/more intensive distraction, and therefore provides the distraction suggestion at node B, which in this case represents “having a fun conversation with a chat-bot.” On the other hand, if the component of user-response vector corresponding to engagement level (i.e. edge A-E) is high, this indicates to distraction suggestion provider 126 to suggest a distraction that is more likely to grab the user's attention. In this scenario, distraction suggestion provider 126 may provide the distraction suggestion at node E, which is to “send the user a video”.

In alternative embodiments, and with continued reference to FIG. 5, if the user was happy (node A) in its response (e.g. R1=[1, 0, 0]), distraction suggestion provider 126 will remain at node A and continue providing the same distraction suggestion to the user.

Referring back to FIGS. 1 and 2, post-distraction suggestion tracker 128 includes a set of programming instructions, in cognitive quit smoking assistant 120, to track whether the user has followed the one or more context specific distraction suggestions (step 210). In exemplary embodiments, post-distraction suggestion tracker 128 may incorporate a variety of input factors to determine what made the distraction suggestion effective or not. In an exemplary embodiment, post-distraction suggestion tracker 128 is capable of tracking the outcome of a given distraction suggestion, and taking feedback from the user, without the need for actual hardware devices or measurement tools to determine if a user has engaged in a smoking event or not.

For example, changes in smoking values may take into consideration previously discussed input factors (i.e. physical, mental, social/pattern inputs), user context (i.e. user in office, home, meeting, bar), a user's group smoking network 130, and so forth. This information may then be stored in smoking history database 142 and distraction suggestion feedback database 144 for use in subsequent cycles.

In alternative embodiments, post-distraction suggestion tracker 128 may use any accessible hardware devices to track whether the user has engaged in a smoking event or not. For example, known accessible hardware devices to detect whether a user has smoked or not may include a wrist accelerometer, which automatically detects puffing and smoking of a user's wrist activity. In another embodiment, an example of a passive device used to detect whether a user has engaged in a smoking event or not consists of a cigarette case that automatically provides a signal that a cigarette has been smoked each time the lid is raised. In yet another embodiment, an example of a smoking detection device may consist of a wristwatch-type device having a button that the user taps each time a cigarette is smoked, together with a timer that calculates the time between each cigarette smoked.

FIG. 6 is a block diagram depicting components of a computing device (such as computing device 110 and database server 130 as shown in FIG. 1), in accordance with an embodiment of the present invention. It should be appreciated that FIG. 6 provides only an illustration of one implementation and does not imply any limitations with regard to the environments in which different embodiments may be implemented. Many modifications to the depicted environment may be made.

Computing device 110 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. Communications fabric 918 may be implemented with any architecture designed for passing data and/or control information between processors (such as microprocessors, communications and network processors, etc.), system memory, peripheral devices, and any other hardware components within a system.

One or more operating systems 910, and one or more application programs 911, such as recipe optimizer assistant 120, may be stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Computing device 110 may also include a R/W drive or interface 914 to read from and write to one or more portable computer readable storage media 926. Application programs 911 on computing device 110 may be stored on one or more of the portable computer readable storage media 926, read via the respective R/W drive or interface 914 and loaded into the respective computer readable storage media 908.

Computing device 110 may also include a network adapter or interface 916, such as a TCP/IP adapter card or wireless communication adapter (such as a 4G wireless communication adapter using OFDMA technology). Application programs 911 on computing device 110 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers.

Computing device 110 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may comprise hardware and software (stored on computer readable storage media 908 and/or ROM 906).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and controlling access to data objects 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Based on the foregoing, a computer system, method, and computer program product have been disclosed. However, numerous modifications and substitutions can be made without deviating from the scope of the present invention. Therefore, the present invention has been disclosed by way of example and not limitation.

What is claimed is:

1. A computer-implemented method for providing a cognitive quit smoking assistant, comprising:
detecting one or more smoking triggers of the user by using one or more sensors associated with a computing device of the user,
predicting a smoking event of the user based on receiving the detected one or more smoking triggers of the user and one or more lead indicators for a smoking event of the user;
providing the user with one or more context specific distraction suggestions to avoid the smoking event; and
tracking progress of the user based on the user following the one or more context specific distraction suggestions.

2. The computer-implemented method of claim 1, further comprising:
receiving feedback, from the user, to the one or more context specific distraction suggestions.

3. The computer-implemented method of claim 1, wherein the one or more smoking triggers of the user is selected from a group consisting of at least one of a physical input, a mental input, and a social and pattern input.

4. The computer-implemented method of claim 1, wherein the one or more lead indicators for a smoking event of the user is selected from a group consisting of at least one of a situational context of the user, smoking history data of the user either following or not following the one or more context specific distraction suggestions, and a group smoking network of the user.

5. The computer-implemented method of claim 1, further comprising:
developing a set of rules for providing the one or more context specific distraction suggestions to the user, using a machine learning (ML) model, based on the detected one or more smoking triggers and one or more lead indicators for a smoking event of the user.

6. The computer-implemented method of claim 5, wherein the ML model changes dynamically based on received feedback from the user.

7. The computer-implemented method of claim 1, wherein the one or more context specific distraction suggestions are sequential and increase in intensity based on the received feedback from the user.

8. A computer program product, comprising a non-transitory tangible storage device having program code embodied therewith, the program code executable by a processor of a computer to perform a method, the method comprising:
detecting one or more smoking triggers of the user by using one or more sensors associated with a computing device of the user,
predicting a smoking event of the user based on receiving the detected one or more smoking triggers of the user and one or more lead indicators for a smoking event of the user;
providing the user with one or more context specific distraction suggestions to avoid the smoking event; and
tracking progress of the user based on the user following the one or more context specific distraction suggestions.

9. The computer program product of claim 8, further comprising:
receiving feedback, from the user, to the one or more context specific distraction suggestions.

10. The computer program product of claim 8, wherein the one or more smoking triggers of the user is selected from a group consisting of at least one of a physical input, a mental input, and a social and pattern input.

11. The computer program product of claim 8, wherein the one or more lead indicators for a smoking event of the user is selected from a group consisting of at least one of a situational context of the user, smoking history data of the user either following or not following the one or more context specific distraction suggestions, and a group smoking network of the user.

12. The computer program product of claim 8, further comprising:
developing a set of rules for providing the one or more context specific distraction suggestions to the user, using a machine learning (ML) model, based on the detected one or more smoking triggers and one or more lead indicators for a smoking event of the user.

13. The computer program product of claim 12, wherein the ML model changes dynamically based on received feedback from the user.

14. The computer program product of claim 8, wherein the one or more context specific distraction suggestions are sequential and increase in intensity based on the received feedback from the user.

15. A computer system, comprising:
one or more computer devices each having one or more processors and one or more tangible storage devices; and
a program embodied on at least one of the one or more storage devices, the program having a plurality of program instructions for execution by the one or more processors, the program instructions comprising instructions for:
detecting one or more smoking triggers of the user by using one or more sensors associated with a computing device of the user,
predicting a smoking event of the user based on receiving the detected one or more smoking triggers of the user and one or more lead indicators for a smoking event of the user;
providing the user with one or more context specific distraction suggestions to avoid the smoking event; and
tracking progress of the user based on the user following the one or more context specific distraction suggestions.

16. The computer system of claim 15, further comprising:
receiving feedback, from the user, to the one or more context specific distraction suggestions.

17. The computer system of claim 15, wherein the one or more smoking triggers of the user is selected from a group consisting of at least one of a physical input, a mental input, and a social and pattern input.

18. The computer system of claim 15, wherein the one or more lead indicators for a smoking event of the user is selected from a group consisting of at least one of a situational context of the user, smoking history data of the user either following or not following the one or more context specific distraction suggestions, and a group smoking network of the user.

19. The computer system of claim 15, further comprising:
developing a set of rules for providing the one or more context specific distraction suggestions to the user, using a machine learning (ML) model, based on the detected one or more smoking triggers and one or more lead indicators for a smoking event of the user.

20. The computer system of claim 19, wherein the ML model changes dynamically based on received feedback from the user.
